(19) United States
(12) Patent Application Publication
(10) Pub. No.: US 2025/0266178 A1
(43) Pub. Date: Aug. 21, 2025

(54) THERMAL POWER REACTOR

(71) Applicant: SOLETANCHE FREYSSINET S.A.S., Rueil-Malmaison (FR)

(72) Inventor: Peter MORRIS, Rueil-Malmaison (FR)

(73) Assignee: SOLETANCHE FREYSSINET S.A.S., Rueil-Malmaison (FR)

(21) Appl. No.: 18/563,538

(22) PCT Filed: May 23, 2022
(86) PCT No.: PCT/EP2022/063938

§ 371 Date: Nov. 22, 2023

(30) Foreign Application Priority Data
May 26, 2021 (GB) 2107508.0

(51) Int. Cl. G21C 15/00; B64G 1/42; B82Y 30/00; G21B 1/17; G21D 5/02

(52) U.S. Cl. CPC G21C 15/00; B82Y 30/00; G21B 1/17; G21D 5/02; B64G 1/422

(57) ABSTRACT

A thermal power reactor is provided. The thermal power reactor includes a reactor core arranged to generate thermal energy and a solid state thermal conductor including a graphene based metamaterial. The solid state thermal conductor extends into and is thermally integrated with the reactor core. The solid state thermal conductor is arranged to transfer thermal energy generated by the reactor core away from the reactor core.

This invention relates to a thermal power reactor, in particular a thermal power reactor for use in a spacecraft or planetary environment.

Nuclear fission reactors are able to generate a large amount of energy relative to the mass of the fissile material, e.g. uranium-235, used in the reactor. While many nuclear fission reactors supply power for civilian consumer use, nuclear fission reactors have been considered potential power sources for use in space, e.g. to power spacecraft or space probes.

An example of a nuclear fission reactor system designed for use in spacecraft is the Kilopower Reactor Using Stirling Technology (KRUSTY) developed by NASA. KRUSTY is a compact, fast reactor which uses a “heatpipe” heat transport system in which sodium is used as a fluid coolant.

Fluid coolant systems, in fission reactor systems developed for use in space, may present a number of potential weaknesses in the system. The requirement for coolant pipes through which a fluid reliably flows may result in a complicated reactor design with a large amount of pipe work and the potential for leakage of the fluid coolant. For space exploration, simpler designs are often favourable because complicated designs may create more failure modes that could result in catastrophic consequences on a mission. Reducing the number of moving parts (such as a flowing coolant, or components required to produce coolant flow) may also be desirable for space applications, as moving parts may add further potential failure modes in a reactor that may not be able to be rectified once the spacecraft has been launched into a space environment.

A fluid coolant may itself provide a number of possible failure modes for the reactor: loss of coolant flow (which results in the reactor failing to be cooled and prevents it's prime function of heat transfer from taking place) and loss of coolant (which stops the reactor functioning and may pose the risk of an exothermic reaction of the fluid coolant with external materials (e.g. sodium and water)). All of these are undesirable in a reactor designed for use in space.

An aim of the present application is to provide an improved thermal power reactor, e.g. better suited to implementation in a spacecraft or for other space related functions.

When viewed from a first aspect, the present invention provides a thermal power reactor comprising:
a reactor core arranged to generate thermal energy; and
a solid state thermal conductor comprising a graphene based metamaterial, the solid state thermal conductor extending into and thermally integrated with the reactor core, wherein the solid state thermal conductor is arranged to transfer thermal energy generated by the reactor core away from the reactor core.

The present invention relates to a thermal power reactor, in which (e.g. fission) reactions take place to generate thermal energy. A solid state thermal conductor is in contact with the reactor core such that the thermal energy produced in the reactor can be transferred out of the reactor core via the solid state thermal conductor. The solid state thermal conductor is thus able to transfer the thermal energy from the core. The solid state thermal conductor comprises a graphene based metamaterial, which may provide increased thermal conductivity compared to other materials.

The skilled person will appreciate that the provision of a solid state thermal conductor in a thermal (e.g. fission) power reactor helps to provide a better alternative to a fluid coolant system for transferring thermal energy away from the reactor core. Using a solid state thermal conductor may remove the need for moving parts in the cooling system. This helps to improve the reliability of the thermal power reactor, which is particularly important for applications such as space exploration. Removing the fluid coolant system helps to remove the following potential failure modes of the thermal power reactor: loss of coolant and loss of coolant flow. Removing the need for moving parts may reduce the maintenance requirements of the thermal power reactor (e.g. may help to produce a thermal reactor with no maintenance requirements).

In a set of embodiments, the solid state thermal conductor is arranged to transfer thermal energy generated by the reactor core away from the reactor core for subsequent use, e.g. for heating a remote device. For example, the solid state thermal conductor transfers the thermal energy from the core to a device (e.g. a heat conversion unit) for converting thermal energy to electricity. In a set of embodiments, the solid state thermal conductor is arranged to transfer thermal energy generated by the reactor core away from the reactor core for use in converting into electricity. It will be appreciated that by converting the thermal energy into electricity, this electricity can be used, e.g., to power systems on board a spacecraft.

In a set of embodiments the reactor core comprises a nuclear fission reactor core. In other embodiments, the reactor core may comprise the reactor core of a nuclear fusion (or other thermal) reactor. Using a solid state thermal conductor may help to reduce the number of failure modes of these types of reactor. It will be appreciated that failure of a nuclear fission reactor can have catastrophic consequences (e.g. owing to the potential discharge of radioactive material), and thus reducing the risk of failure is important.

The solid state thermal conductor may transfer the thermal energy generated in the reactor core, from the reactor core, in any suitable and desired way. In a set of embodiments, the solid state thermal conductor comprises an internal portion extending into the thermal reactor core and an external portion extending away from the reactor core. Preferably the internal portion and the external portion of the solid state thermal conductor are thermally connected to (e.g. in good thermal contact with) each other. This helps to transfer the thermal energy generated in the reactor core to a device for converting the thermal energy, e.g. into electricity.

The internal portion and the external portion of the solid state thermal conductor may be arranged in any suitable and desired way. In one embodiment the internal portion and the external portion are formed from different materials. This may enable materials for the internal and external portions of the solid state thermal conductor to be chosen that have properties which are suitable for the different requirements inside and outside of the reactor core. However, in other embodiments, the same material may be used for both the internal and external portions of the solid state thermal conductor.

As described above, the solid state thermal conductor comprises a graphene based metamaterial. In a set of embodiments the (e.g. internal portion of the) solid state thermal conductor consists of a graphene based metamaterial or comprises graphite or a (e.g. high thermal conductivity, high strength, high melting point) metal alloy, e.g. tungsten-rhenium. All of these materials help to facilitate an efficient transfer of the generated thermal energy out of the reactor core, e.g. to the external portion of the solid state thermal conductor. Such materials are also able to be formed into suitable structures for forming inside a reactor core and have a good structural integrity against the high temperatures generated in a thermal power reactor core.

In a set of embodiments, the internal portion of the solid state thermal conductor comprises a mesh extending within the reactor core. The fuel of the reactor core may enclose at least part of the mesh. For example, a metallic alloy fuel may be moulded around the mesh. An example of a suitable combination may be a uranium-zirconium or uranium-rhenium fuel encasing a tungsten-rhenium alloy mesh. A mesh helps to increase the surface area of the solid state thermal conductor exposed to the thermal energy generated in the reactor core, which helps to increase the amount of thermal energy able to be extracted from the reactor core.

Preferably the (e.g. mesh of the) internal portion of the solid state thermal conductor has a high thermal conductivity and a high melting point. This helps both to transfer thermal energy from the reactor core and to prevent the solid state thermal conductor melting when the reactor core is generating thermal energy, e.g. when the fuel of the reactor core encloses the mesh.

In a set of embodiments, the internal portion of the solid state thermal conductor comprises a plurality of layers, e.g. a plurality of sheet layers. This helps to increase the surface area of the solid state thermal conductor exposed to the thermal energy generated in the reactor core, which helps to increase the amount of thermal energy able to be extracted from the reactor core. Preferably the sheet layers are substantially planar and/or comprise a thickness that is substantially less than the other two dimensions (e.g. length and width) of the sheet layer.

Providing a solid state thermal conductor comprising a plurality of (e.g. sheet) layers may be suitable for a reactor core comprising compact type fuel cores, e.g. formed from discrete compact, particulate filled fuel discs. The plurality of layers may then be positioned in between the discrete compact fuel discs, e.g. such that the plurality of layers interleave the discrete compact fuel discs. The plurality of layers may be formed from (e.g. comprise or consist of) graphite or a graphene based metamaterial or a high (e.g. thermal) conductivity metal alloy such a tungsten-rhenium.

In one embodiment the fuels discs comprise enriched tri-structural-isotropic (TRISO) fuel particles in a carbon based matrix. TRISO matrix fuels have high melting points and thus are suitable for use in compact type fuel cores which function at particularly high temperatures. TRISO matrix fuels also have negative reactivity feedback mechanisms (such as thermal expansion and contraction) and thus support autonomous control (e.g. human intervention to control the fission reaction may not be required), which is particularly suitable for reactors designed for use in space (e.g. in spacecraft or in a planetary environment).

In a set of embodiments, the (e.g. external portion of the) solid state thermal conductor comprises graphene or consists of a metamaterial comprising graphene. Graphene may be particularly suitable owing to its high thermal conductivity. It will be appreciated that the high thermal conductivity of graphene is much greater than that of fluid sodium, for example, the latter of which has a measured thermal conductivity of approximately 65-85 Wm⁻¹K⁻¹, e.g. over the range 100-600° C.

In a preferred embodiment the solid state thermal conductor (e.g. when the solid state thermal conductor comprises graphene or a metamaterial comprising (or consisting of) graphene) is arranged to have a thermal conductivity greater than 2000 Wm⁻¹K⁻¹, e.g. greater than 3000 Wm⁻¹K⁻¹, e.g. greater than 4000 Wm⁻¹K⁻¹, e.g. greater than 5000 Wm⁻¹K⁻¹. This helps to transfer heat effectively from the reactor core, owing to the high thermal conductivity of the solid state thermal conductor. In a set of embodiments, the external portion of the solid state thermal conductor comprises multiple (e.g. sheet) layers of graphene. Graphene is formed from a two-dimensional hexagonal lattice of carbon atoms. Thus, multiple layers of the two-dimensional lattice may be used to form a solid state thermal conductor of adequate volume to conduct a suitable amount of thermal energy away from the reactor core, e.g. for generating electricity. Similarly, in a set of embodiments, the external portion of the solid state thermal conductor comprises (or consists of) multiple layers of a graphene based metamaterial.

In a set of embodiments, the external portion of the solid state thermal conductor comprises one or more intermediate separating (e.g. sheet) layers arranged to interleave the multiple (e.g. sheet) layers of graphene or graphene based metamaterial. The intermediate separating layers help to separate the layers of graphene such that the layers of graphene do not come into direct contact with each other. This helps to maintain the heat conducting properties of each, e.g. single sheet, layer of graphene.

The intermediate separating (e.g. sheet) layers may be arranged so that they are sandwiched between two (e.g. sheet) layers of graphene or graphene based metamaterial. There may be any suitable number of additional layers, alternating between intermediate (e.g. sheet) layers and graphene or graphene based metamaterial (e.g. sheet) layers. Preferably the intermediate separating and/or graphene or graphene based metamaterial sheet layers are substantially planar and/or comprise a thickness that is substantially less than the other two dimensions (e.g. length and width) of the sheet layer.

The intermediate separating (e.g. sheet) layers may be formed from any suitable and desirable material. In a set of embodiments the separating (e.g. sheet) layers comprise copper. Using copper (e.g. sheets) to prevent the graphene layers from contacting each other helps to reduce the effect on the quantum mechanical properties, and therefore conductivity, of the individual sheets on each other.

In one embodiment the external portion of the solid state thermal conductor comprises an outer insulating layer, e.g. formed from gold foil. This helps to further insulate the (e.g. graphene or graphene based metamaterial layers of the) external portion of the solid state thermal conductor.

In a set of embodiments, the graphene of the solid state thermal conductor comprises graphene ribbons. Graphene ribbons are typically strips of graphene, e.g. with a thickness of less than about 50 nm. Graphene ribbons help to provide a continuous sheet of graphene over an extended length, with a high thermal conductivity, such that an efficient elongate solid state thermal conductor may be provided.

In a set of embodiments, the external and/or internal portion of the solid-state thermal conductor comprises (or consists of) a graphene based metamaterial. The term ‘metamaterial’ may be understood to mean a material comprising unit cells, wherein the material has its function dictated by both its cellular architecture and its chemical composition. Typically, metamaterials have properties not found in nature—e.g. increased conductivity.

In a set of embodiments, the graphene based metamaterial comprises (or consists of) carbon nanotube based threads or rope. Carbon nanotubes are typically formed from a closed, cylindrical two-dimensional hexagonal lattice of carbon atoms and may possess high thermal conductivity.

Having the external and/or internal portion of the solid-state thermal conductor comprising (or consisting of) a thread or rope made from a carbon nanotube based material allows it to be formed into any suitable and desired configuration. Using graphene based thread or rope-like conductors may allow them to be constructed into either an elongate (e.g. one dimensional) form or be arranged into two-dimensional shapes (i.e. extending in at least two directions—e.g. forming a surface—e.g. a sheet (layer)). Such materials may also flex or bend without substantially affecting the conductive mechanisms of the solid state thermal conductor.

A plurality of nanotube threads may be weaved together to form a rope-like structure. Thread-like or rope-like carbon nanotube structures may be used to form a solid-state thermal conductor of adequate volume to conduct a suitable amount of thermal energy away from the reactor core, e.g. for generating electricity. In a set of embodiments, the threads are wrapped to produce a string or rope having varying thicknesses from the um scale to the cm scale, e.g. between 1 μm and 10 cm, e.g. between 10 μm and 1 cm, e.g. between 100 μm and 10 mm, e.g. between 500 μm and 1 mm.

In order to optimise conductivity it may be possible to produce a thicker carbon nanotube thread or twine based material with less wrapping or twisting. In a set of embodiments, therefore, the carbon nanotube based threads or rope have thicknesses from the um scale to the cm scale, e.g. between 1 μm and 10 cm, e.g. between 10 μm and 1 cm, e.g. between 100 μm and 10 mm, e.g. between 500 μm and 1 mm. These thicker carbon nanotube based threads or rope may require less relative helical wrapping and thus may exhibit increased conductivity, compared to thinner alternatives, as wrapping serves to impede conductivity to some extent.

The internal and external portions of the solid state thermal conductor may be connected to each other in any suitable and desired way. When the internal and external portions of the solid state thermal conductor comprise the same material, the internal and external portions of the solid state thermal conductor may be continuous extensions of each other.

In a set of embodiments, when the internal and external portions of the solid state thermal conductor comprise (or consist of) graphene or a graphene based meta-material, the internal and external portions of the solid state thermal conductor are connected by direct pressing and sintering. This helps to make an effective, strong and thermally conductive joined region with minimum impedance to heat flow. This may be particularly effective for embodiments comprising a TRISO compacted fuel based core, where any graphene based conductor may be pressed and sintered directly into the graphite or graphene meta-material based fuel compact during fuel manufacture.

When the internal and external portions of the solid state thermal conductor are formed from different materials, the internal portion (e.g. formed from graphite or a metal alloy) and the external portion (e.g. formed from graphene or a graphene based metamaterial) may be connected together by an adhesive or mechanical fastener, which helps to ensure a good (surface area) contact between the internal and external portions. The internal and external portions may be connected by welding, crimping, or shrink fitting. In a set of embodiments, where the internal and/or external portion comprise (or consist of) metal or graphene based metamaterials, a high temperature carbon graphene flake or nanotube doped epoxy is used to join the internal and external portions of the solid state thermal conductor.

In a set of embodiments the external portion of the solid state conductor comprises a void for receiving the internal portion of the solid state thermal conductor. For example, the internal portion, which may be protruding from the core, may slot into the void in the external portion.

In one set of embodiments, the thermal power reactor comprises a heat conversion unit for converting thermal energy to electricity. This allows the thermal energy generated in the reactor core to be converted into electricity. Preferably the heat conversion unit is thermally connected to the reactor core via the solid state thermal conductor (e.g. the solid state thermal conductor is thermally connected to the heat conversion unit). Thus the energy is transferred from the reactor core to the heat conversion unit by the solid state thermal conductor. In a set of embodiments, the external portion of the solid state thermal conductor is connected to the heat conversion unit.

In a set of embodiments, the heat conversion comprises a solid state heat conversion unit, e.g. a thermo-electric or thermo-photo-electric or thermo-acoustic-electric generator. For reactors intended for use in space, using a solid state heat conversion unit to convert heat energy produced in the reactor core to electrical energy helps to reduce the number of moving parts (e.g. to zero). Moving parts are more susceptible to failure and are difficult (if not impossible) to fix should they fail in a commissioned spacecraft or on a planetary surface.

In another set of embodiments, the heat conversion unit comprises a Stirling engine. A Stirling engine converts heat energy to kinetic energy (and then, e.g., electricity) by the expansion and compression of working gases in the Stirling engine. Stirling engines may be more efficient mechanisms for converting heat energy from the thermal reactor core in larger scale thermal reactors, especially for nuclear fission reaction intended for supplying commercial power, where a larger amount of heat energy is produced at any given time and reducing moving parts is a less important consideration (compared with a reactor intended for use in space exploration).

In a set of embodiments, the solid state thermal conductor comprises a portion that extends into the heat conversion unit, for transferring thermal energy into the heat conversion unit. Preferably, the external portion of the solid state thermal conductor extends into the heat conversion unit. This portion of the solid state thermal conductor may be formed from (e.g. comprise or consist of) graphene, or a graphene based metamaterial, or a highly thermally conductive metal alloy, or may be formed from (e.g. comprise or consist of) graphite. The portion of the solid state thermal conductor that extends into the heat conversion unit is preferably in good thermal contact with the heat conversion unit. This aids thermal energy to be transferred from the solid state thermal conductor to the heat conversion unit.

In embodiments in which the heat conversion unit comprises a solid state heat conversion unit, the portion of the solid state thermal conductor that extends into the solid state heat conversion unit is arranged to transfer thermal energy to the solid state heat conversion unit, for converting the thermal energy into electricity. The solid state heat conversion unit may then output electrical energy.

In embodiments in which the heat conversion unit comprises a solid state heat conversion unit, preferably the solid state heat conversion unit is positioned in contact with (e.g. a reflective and/or neutron absorbent shield of) the reactor core, as will be discussed further below. Thus the solid state thermal conductor may comprise an internal portion that extends into the reactor core and an external portion that extends into the solid state heat conversion unit, e.g. with no intermediate portion.

In embodiments in which the heat conversion unit comprises a Stirling engine, the portion of the solid state thermal conductor that extends into the Stirling engine is arranged to transfer thermal energy to a working fluid, e.g. the solid state thermal conductor extends into the “hot end” of the Stirling engine. Transferring thermal energy to the working fluid (e.g. a gas) of the Stirling energy results in the working fluid expanding. The expansion of the working fluid may then drive a piston, e.g. to generate kinetic energy for converting into electricity.

In a set of embodiments in which the external portion of the solid state thermal conductor comprises (e.g. multiple (e.g. sheet) layers of) graphene or a graphene based metamaterial, the (e.g. layers of) graphene or graphene based metamaterial may be wrapped around the (e.g. hot end of the) Stirling engine. This helps to provide efficient transfer of thermal energy from the external portion of the solid state thermal conductor to the working fluid of the Stirling engine.

In embodiments in which the heat conversion unit comprises a Stirling engine, preferably the Stirling engine is remote from (i.e. not in contact with) the reactor core. Thus the external portion of the solid state thermal conductor preferably extends between the reactor core and the Stirling engine (and preferably extends into the Stirling engine). Preferably the solid state thermal conductor (e.g. the intermediate part of the external portion that extends between the reactor core and the Stirling engine) is elongate (i.e. has a length greater than a width and a depth).

When using certain fuels in the reactor core that comprise or produce contaminating materials (e.g. by-products), preferably the reactor core is arranged to contain these contaminating materials in the reactor core. For example, when the reactor core comprises a nuclear fission reactor core, preferably the reactor core is arranged to substantially prevent neutrons and gamma photon radiation produced in the fission reaction from leaving the reactor core.

Therefore, in a set of embodiments, the thermal power reactor comprises a (e.g. reflective) shield. The shield may be formed from a metal or metal composite. Preferably the shield encases the reactor core. The shield helps to reduce the amount of radiation materials that otherwise may escape from the reactor core. For example, the shield may absorb and/or reflect neutrons and gamma photon radiation produced by fission reaction in the reactor core.

In a set of embodiments the solid state thermal conductor penetrates (extends through) the shield. This helps to transfer thermal energy away from a reactor core encased in a shield. Preferably, the solid state thermal conductor fully penetrates the shield such that the solid state thermal conductor is in direct (thermal) contact with the reactor core.

Preferably, when the heat conversion unit comprises a solid state heat conversion unit, the solid state heat conversion unit is located at (e.g. on an external wall of) the shield of the reactor core. This helps to reduce any heat losses that may otherwise occur between the solid state heat conversion unit and reactor core.

The Applicant has appreciated that in embodiments in which the solid state thermal conductor penetrates the shield, this may form a route along which radiation and/or contaminating materials may escape from the reactor core through the shield via the solid state thermal conductor. In a set of embodiments, the solid state thermal conductor comprises a non-linear portion extending through the shield.

The non-linear portion may, for example, comprise an S-shaped, a U-shaped bend or an otherwise labyrinthine path. The non-linear portion (which is preferably located within the shield of the reactor core) helps to reduce any radiation and/or contaminating material from escaping through the shield as the non-linear portion prevents a linear route through the solid state thermal conductor along which the contaminating materials may escape.

Certain embodiments of the present invention will now be described, by way of example only, with reference to the accompanying drawings in which:

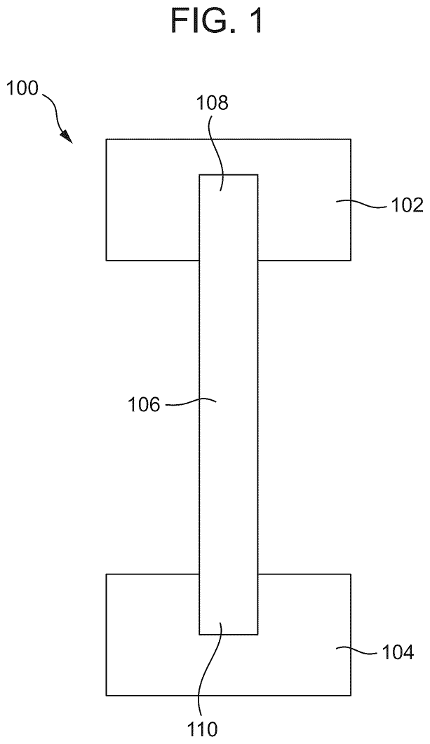

FIG. 1 shows schematically a thermal power reactor according to an embodiment of the present invention;

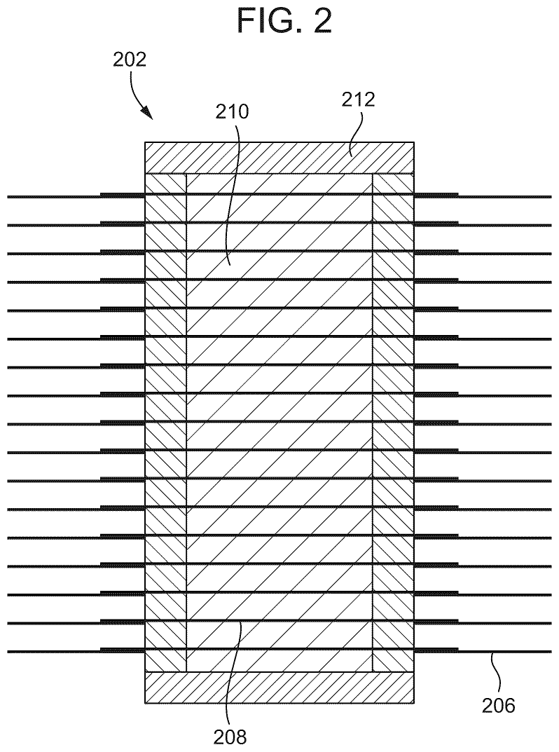

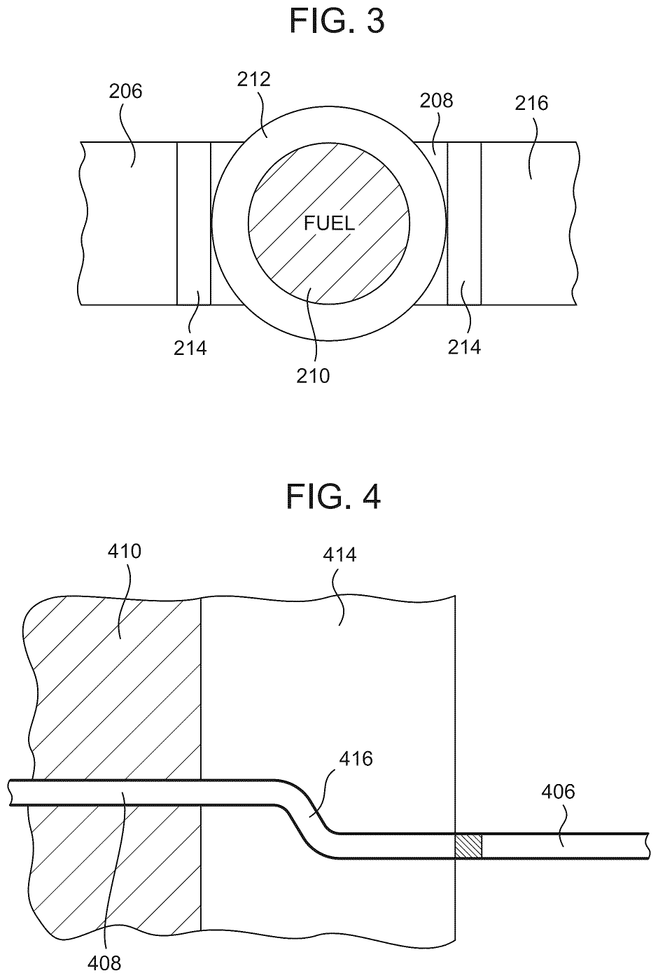

FIGS. 2 and 3 show cross-sections of a reactor core for use with a thermal power reactor according to an embodiment of the present invention;

FIG. 4 shows a cross-section through the wall of a reactor core for use with a thermal power reactor according to an embodiment of the present invention;

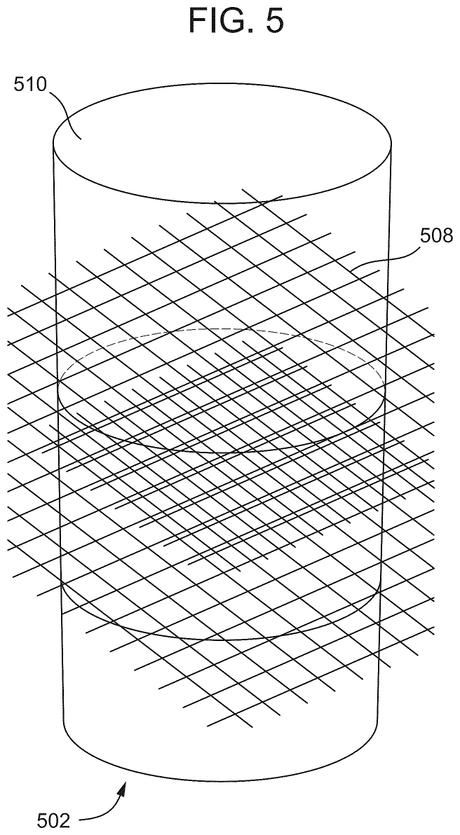

FIG. 5 shows schematically a reactor core for use with a thermal power reactor according to an embodiment of the present invention;

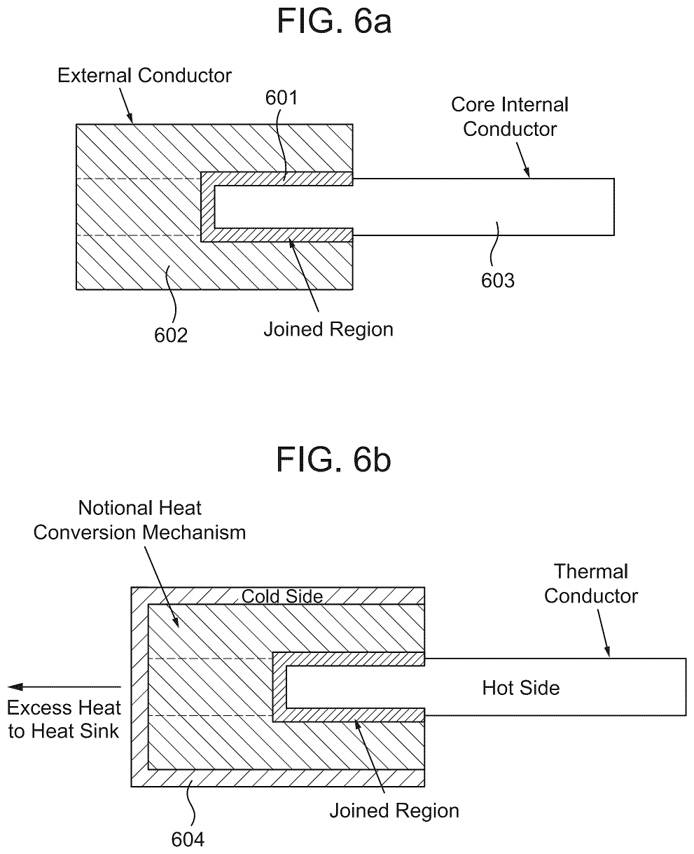

FIGS. 6a and 6b show schematically the internal portion interfacing with the external portion of the conductor; and

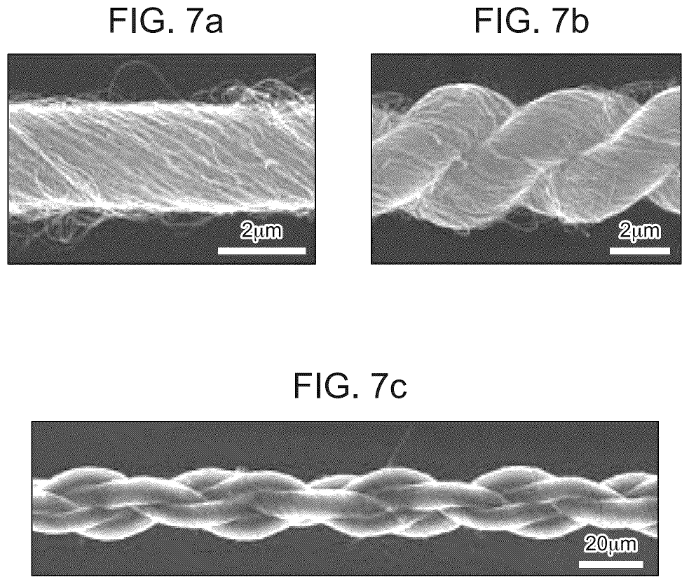

FIG. 7 shows carbon nanotube rope as an example of a graphene based metamaterial for use with a thermal power reactor according to an embodiment of the present invention.

Various embodiments of a thermal power reactor will now be described. The thermal power reactors shown may be suitable for use in space, e.g. to act as a power source for a spacecraft or space probe, or on a surface landing mission.

FIG. 1 shows schematically a thermal power reactor 100 in accordance with an embodiment of the present invention. The thermal power reactor 100 may be a nuclear fusion reactor used for commercial power generation. In such examples, the thermal power reactor 100 may be large scale, capable of producing a commercially beneficial power output. The thermal power reactor 100 may also be a nuclear fusion reactor implemented in a spacecraft or a space probe. In such examples, the thermal power reactor 100 may be a compact, small reactor providing the small amount of power required by the spacecraft. It will also be appreciated by a person skilled in the art that the thermal power reactor 100 may be a nuclear fusion reactor or furnace, e.g. for burning coal.

The thermal power reactor 100 comprises a reactor core 102. The type of reactor core 102 used corresponds to the type of thermal power reactor 100. For example, when the thermal power reactor 100 is a nuclear fission reactor, the reactor core 102 is a nuclear fission core. The reactor core 102 further comprises a fuel (not shown in FIG. 1) for generating thermal energy. In the example of a nuclear fission reactor, the fuel may contain nuclear isotopes (e.g. uraninum-235, plutonium-239 and/or uranium-238) that are used in fission reactions to generate thermal energy. The fuel may be a mixture of such nuclear isotopes depending on the requirements of the thermal power reactor 100.

The thermal power reactor 100 further comprises a heat conversion unit 104. The heat conversion unit 104 may, for example, be a thermoelectric generator or a Stirling engine. The heat conversion unit 104 converts thermal energy produced in the reactor core 102 to another form of energy, which may be more suitable for particular applications. For example, the heat conversion unit 100 may convert the thermal energy into kinetic energy (e.g. when the heat conversion unit 100 comprises a Stirling engine). This kinetic energy may be used to drive a turbine (or otherwise a magnetic induction device) to be converted into electrical energy. The heat conversion unit 100 may also convert the thermal energy directly into electrical energy (e.g. when the heat conversion unit 100 comprises a thermoelectric generator).

In order for thermal energy to be transferred from the reactor core 102 to the heat conversion unit 104, the reactor core 102 and the heat conversion unit 104 must be thermally connected such that thermal energy can flow between them. This thermal connection is provided by the solid state thermal conductor 106 that is arranged between, and in good thermal contact with, the reactor core 102 and the heat conversion unit 104.

The solid state thermal conductor 106 is formed at least partially from graphene or a graphene based metamaterial (e.g. carbon nanotube based threads or rope), e.g. in the section extending between the reactor core 102 and the heat conversion unit 104. This may be seen in embodiments in which the heat conversion unit is located at some distance from the reactor core. In this section, the solid state thermal conductor 106 comprises multiple layers of graphene ribbons or graphene based thread or rope (e.g. arranged into sheets). The multiple layers of graphene ribbons may be interleaved by multiple (e.g. sheet) layers of copper separating the layers of graphene and covered in an outer layer of infrared photon reflective (e.g. gold) foil. When the heat conversion unit 104 comprises a Stirling engine, the layers of graphene or graphene based metamaterial are wrapped around the hot end of the Stirling engine to transfer heat generated in the reactor core 102 into the working fluid of the Stirling engine.

To transfer thermal energy between the reactor core 102 and the heat conversion unit 104, the solid state thermal conductor 106 is in thermal contact with both. In the embodiment shown in FIG. 1, the solid state thermal conductor 106 has an internal portion 108 which extends into the reactor core 102. Exemplary arrangements of the internal portion 108 of the solid state thermal conductor 106 and the reactor core 102 are shown in FIGS. 2, 3 and 5. In the embodiment shown in FIG. 1, the solid state thermal conductor has an external portion 110 which extends into the heat conversion unit 104. Both or one of the portions 108, 110 may be formed from graphene or a graphene based metamaterial, or may be formed from a high conductivity metal alloy.

FIG. 2 shows a cross-section of a reactor core for use with a thermal power reactor according to an embodiment of the present invention. FIG. 2 shows an exemplary arrangement of the internal portion 208 of a solid state thermal conductor 206 within a reactor core 202. In the arrangement shown in FIG. 2, the reactor core 202 contains a plurality of (e.g. TRISO packed, compact graphite) fuel discs 210. The fission reactions that generate thermal energy occur within the fuel discs 210.

The internal portion 208 of the solid state thermal conductor 206 comprises multiple sheets, e.g. of graphite or a graphene based metamaterial or metal (e.g. tungsten-rhenium) alloy. A sheet is placed between each fuel disc 210. The fuel discs 210 are stacked in a manner such as to form a cylinder of discs, with each disc 210 being separated from the adjacent disc 210 in the cylinder by a sheet of the internal portion 208 of the solid state thermal conductor 206. Each sheet conducts thermal energy produced in the fuel discs out of the reactor core 202, and into the remainder of the solid state thermal conductor 206. FIG. 3 shows a different cross-section of the reactor core 202 shown in FIG. 2, showing the solid state thermal conductor 206.

In both FIGS. 2 and 3, a reflecting and/or absorbent neutron/gamma photon shield 212 is shown encasing the fuel discs 210 in the reactor core 202. The shield 212 helps to contain (by reflecting or absorbing) contaminating (e.g. radioactive) materials or radiation (e.g. neutrons and gamma photons) that are produced by the reactions in the reactor core 202. The shield 212 is manufactured from a combination of layers of different materials.

The solid state thermal conductor 206 extends through the shield 212. As shown in FIG. 3, the internal portion 208 of the solid state thermal conductor 206 extends through the shield 212 and is connected to an external portion 216 of the extends through the shield 212 by a thermally conductive coupling 214.

It will be appreciated that in the embodiment shown in FIGS. 2 and 3, the internal portion 208 of the solid state thermal conductor 206 extending through the shield 212 may form a path through the shield 212 through which radiation can escape the from the reactor core 202. FIG. 4 demonstrates a solution to this problem.

FIG. 4 shows a cross-section through the wall of a reactor core for use with a thermal power reactor according to an embodiment of the present invention. FIG. 4 shows a section of the reactor core 410 and a reflecting and/or absorbent shield 414 surrounding the reactor core 410. The internal portion 408 of the solid state thermal conductor 406 penetrates out from the reactor core 410 and through the shield 414. The section of the solid state thermal conductor 406 passing through the shield 414 comprises an S-bend 416. The bend 416 results in the solid state thermal conductor 406 having a non-linear path through the shield 414. This decreases the risk of radiation (e.g. neutrons or gamma photons) from escaping from the reactor core 410 through the shield 414, as there is no linear route through the solid state thermal conductor 406 along which any radiation could pass without interacting with the shield 414 (which may reflect or absorb them).

FIG. 5 shows schematically a reactor core 502 for use with a thermal power reactor according to another embodiment of the present invention. In this embodiment, the internal portion 508 of the solid state thermal conductor is arranged as a mesh, e.g. formed from graphite or a metal (e.g. tungsten-rhenium) alloy. The fuel 510 of the reactor core 502 (e.g. in the form of a metallic alloy fuel) is moulded around the mesh.

FIGS. 6a and 6b show schematically a cross-section of the solid state thermal conductor, showing how the internal portion 603 of the solid state thermal conductor and the external portion 602 of the solid state thermal conductor may be arranged relative to each other.

It can be seen that the external portion 602 has a void—e.g. which may be cuboidal or cylindrical. The internal portion 603 of the solid state conductor is arranged to fit within this void. Between the external portion 602 and the internal portion 603 there is a thermally conductive joined region 601.

In the example shown in FIG. 6a, both the internal portion 603 and external portion 602 are made at least partially from a graphene-based meta-material—e.g. carbon nanotube based threads or rope. In this example, the internal portion 603 and external portion 602 are joined by direct pressing and sintering. This helps to make an effective, strong and thermally conductive joined region 601 with reduced impedance to heat flow.

FIG. 6b shows the embodiment of FIG. 6a in operation. In particular, FIG. 6b shows how heat is transported from the reactor core.

The schematic of FIG. 6b comprises many of the same features as shown in FIG. 6a with the addition of a shaded region indicating the ‘cold side’ 604 of the reactor. Although not shown, the reactor core is in contact with the internal portion of the conductor. The internal portion 603 of the solid state thermal conductor is thermally connected to the reactor core and conducts heat to the joined region 601. The joined region 601 is itself thermally conductive and so allows heat to be conducted through the external portion 602 and away from the reactor core. As mentioned above, both the internal portion 603 and external portion 602 of the solid state thermal conductor in FIGS. 6a and 6b comprise a graphene based metamaterial. FIG. 7 shows carbon nanotube rope as an example of such a graphene based metamaterial. In particular, micrographs (a), (b) and (c) depict different ways of weaving the carbon nanotube threads into rope.

The manufacturing process of the carbon nanotube rope shown in FIG. 7 micrograph (a) will now be described.

The carbon nanotube rope may be manufactured in three stages. In the first stage, a thread composed of nanotubes is extruded from a wet solvent based nanotube solution.

After drying, this produces a thread with nanotubes aligned in one direction along the length of the thread. Multiple threads may then be wrapped (e.g. in a helical fashion) to produce a thicker twine or rope. This is shown in FIG. 7 micrograph (a), where the carbon nanotube threads are simply twisted together.

In another example, shown in FIG. 7 micrograph (b), the carbon nanotube threads can be split into two strands which are each twisted in the same direction (e.g. clockwise) and subsequently are twisted together in the other direction (e.g. anticlockwise). The rope shown in FIG. 7 micrograph (b) is approximately twice as thick as the rope shown in FIG. 7 micrograph (a).

FIG. 7 micrograph (c) shows a braided carbon nanotube rope which is approximately ten times thicker than the example shown in micrograph (a). Thicker structures with less helical wrapping may have increased conductivity.

A benefit of using graphene based thread or rope-like conductors (as seen in FIG. 7) is their ability to be constructed into either an elongate (e.g. one dimensional) form (i.e. simple thread or rope etc.) or to be arranged into two-dimensional shapes (i.e. extending in at least two directions—e.g. forming a surface). Such constructions may also flex or bend without unduly affecting the conductive mechanisms of the solid state thermal conductor. An advantage of such thermal conductors is that they could, in principle, be formed into whatever configuration is considered suitable or desirable.

It may be possible to have metamaterial conductors running completely through the interior of the fuel (metal or TRISO compact: i.e. inside the reactor). This could be in the form of rectangular mesh or flat plane geometries fully integrated with the fuel inside the core.

Ordinarily, in this situation, radiation (e.g. neutron radiation) damage would be a concern as it may have a negative effect on the thermal conductivity of the material over time. However, it is considered by the Applicant that at the elevated temperatures inside the core (typically over 1000° C.) any radiation damage may be constantly annealed out of the conductor. If this approach could be adopted then there would be no need for an interface (e.g. 601) between the interior portion 603 and exterior portion 602 as they would form a single continuous conductor right up to the interface with the heat conversion mechanism (e.g. thermocouple or Stirling engine, etc.).

If it proves difficult or unrealistic to produce single sheet graphene ribbons, then nanotube based thread, twine or rope based constructions provide a robust and more realistic alternative. Graphene flake based films and ribbons are also a possibility. If such flake-based films and ribbons are used in embodiments of the invention, the joining mechanisms described herein (in relation to graphene based metamaterials) would be used.

It will be seen from the above that in at least preferred embodiments a thermal power reactor is provided in which heat is transported away from the reactor core by a solid state thermal conductor, e.g. comprising a graphene based metamaterial and optionally a metal alloy. This helps to reduce or eliminate the need for a fluid coolant which has the associated risks of moving parts and failure owing to fluid leakage. Thus embodiments of the thermal power reactor may be suitable for use in space.

1. A thermal power reactor comprising:
a reactor core arranged to generate thermal energy; and
a solid state thermal conductor comprising a graphene based metamaterial, the solid state thermal conductor extending into and thermally integrated with the reactor core, wherein the solid state thermal conductor is arranged to transfer thermal energy generated by the reactor core away from the reactor core.

2. The thermal power reactor as claimed in claim 1, wherein the solid state thermal conductor comprises an internal portion extending into the thermal reactor core and an external portion extending away from the reactor core.

3. The thermal power reactor as claimed in claim 2, wherein the internal portion and the external portion of the solid state thermal conductor are thermally connected to each other.

4. The thermal power reactor as claimed in claim 2, wherein the internal portion and the external portion are formed from different materials.

5. (canceled)

6. The thermal power reactor as claimed in claim 2, wherein the internal portion of the solid state thermal conductor comprises a mesh extending within the reactor core.

7. The thermal power reactor as claimed in claim 2, wherein the internal portion of the solid state thermal conductor comprises a plurality of layers.

8. The thermal power reactor as claimed in claim 7, further comprising a plurality of fuels discs positioned between the plurality of layers of the solid state thermal conductor.

9. The thermal power reactor as claimed in claim 2, wherein the internal portion of the solid state thermal conductor comprises graphite and/or a metal alloy.

10. The thermal power reactor as claimed in claim 2, wherein the internal portion of the solid state thermal conductor comprises a graphene based metamaterial.

11. The thermal power reactor as claimed in claim 10, wherein the graphene based metamaterial comprises carbon nanotube based threads or rope.

12. The thermal power reactor as claimed in claim 2, wherein the external portion of the solid state thermal conductor comprises a plurality of layers of graphene and/or a graphene based metamaterial.

13. The thermal power reactor as claimed in claim 12, wherein the external portion of the solid state thermal conductor comprises one or more intermediate separating layers that interleave the multiple layers of graphene and/or graphene based metamaterial

14. (canceled)

15. The thermal power reactor as claimed in claim 2, wherein the external portion of the solid state thermal conductor comprises a plurality of layers of a graphene based metamaterial, and wherein the plurality of layers of the graphene based metamaterial comprise carbon nanotube based threads or rope.

16. (canceled)

17. The thermal power reactor as claimed in claim 13, wherein the separating layers comprise copper.

18. The thermal power reactor as claimed in claim 2, wherein the external portion of the solid state thermal conductor comprises an outer insulating layer.

19. The thermal power reactor as claimed in claims claim 1, wherein the thermal power reactor comprises a heat conversion unit for converting thermal energy to electricity.

20. (canceled)

21. The thermal reactor as claimed in claim 19, wherein the heat conversion unit comprises a Stirling engine and wherein an external portion of the solid state thermal conductor extends into the Stirling engine, wherein the an external portion of the solid state thermal conductor is arranged to transfer thermal energy to a working fluid of the Stirling engine.

22. The thermal reactor as claimed in claim 19, wherein the heat conversion unit comprises a Stirling engine and wherein the external portion of the solid state thermal conductor comprises graphene and/or a graphene based metamaterial, wherein the graphene and/or graphene based metamaterial is wrapped around the Stirling engine.

23. (canceled)

24. The thermal reactor as claimed in claim 19,
wherein the heat conversion unit comprises a Stirling engine,
wherein the external portion of the solid state thermal conductor comprises a graphene based metamaterial,
wherein the graphene based metamaterial is wrapped around the Stirling engine, and
wherein the graphene based metamaterial wrapped around the Stirling engine comprises carbon nanotube based threads or rope.

25. The thermal reactor as claimed in claim 19, wherein the Stirling engine is remote from the reactor core.
